(19) United States
(12) Patent Application Publication
(10) Pub. No.: US 2021/0251231 A1
(43) Pub. Date: Aug. 19, 2021

(54) METHOD OF AND A COMPOSITION FOR IMPROVING BREAKING DORMANCY AND UNIFORMITY OF RIPENING FOR PERENNIAL FRUITS

(71) Applicant: Suntton Company Limited, Wan Chai (CN)

(72) Inventors: Xi Wang, Chilliwack (CA); Liping Peng, Sacramento, CA (US)

(73) Assignee: Suntton Company Limited

(21) Appl. No.: 17/200,627

(22) Filed: Mar. 12, 2021

Related U.S. Application Data
(63) Continuation-in-part of application No. 17/158,965, filed on Jan. 26, 2021.
(60) Provisional application No. 62/991,963, filed on Mar. 19, 2020.
(60) Provisional application No. 62/976,946, filed on Feb. 14, 2020.

(51) Int. Cl. A01N 43/22; A01N 59/00; A01N 37/34; A01N 35/06; A01N 31/06; A01N 43/20; A01N 43/16; A01N 43/38; A01N 37/10; A01N 37/18; A01N 37/38; A01N 43/56; A01N 43/12; A01N 43/90; A01N 43/40

(52) U.S. Cl. CPC A01N 43/22; A01N 43/40; A01N 37/34; A01N 35/06; A01N 31/06; A01N 43/20; A01N 43/16; A01N 43/38; A01N 37/10; A01N 37/18; A01N 37/38; A01N 43/56; A01N 43/12; A01N 43/90; A01N 59/00

(57) ABSTRACT

This disclosure includes a method of improving dormancy break and of perennial tree fruits, and ameliorating uniformity of ripening for manual and mechanical harvests, by the trunk and foliar application of brassinosteroids. The method is able to be based on natural and synthesized material, 24-epibrassinolide and other commercial brassinolides, in contrast to those chemicals based on hydrogen cyanamide or calcium ammonium nitrate that causes skin irritation and serious eye irritation. The method includes inducing bud-breaking of all perennial tree fruits, especially all grapevines after forced dormancy in tropical and subtropical climates, and later treatments with brassinolides or other growth regulators at fruit sizing stage and/or early ripening stage for uniform ripening. This disclosure provides alternative and safe option and possibilities to growers for labor saving manual and mechanical harvests.

### CROSS-REFERENCE TO RELATED APPLICATION(S)

This application is a continuation-in-part of co-pending U.S. patent application Ser. No. 17/158,965, filed Jan. 26, 2021, and entitled “Plant Regulator Compositions.” U.S. patent application Ser. No. 17/158,965 claims priority of U.S. Provisional Application, Ser. No. 62/976,946, filed Feb. 14, 2020, and entitled “Plant Regulator Compositions.” This application incorporates U.S. patent application Ser. No. 17/158,965 and U.S. Provisional Application, Ser. No. 62/976,946 in their entirety by reference for all purposes.

Further, this application claims priority under 35 U.S.C. § 119(e) of the U.S. Provisional Patent Application Ser. No. 62/991,963, filed Mar. 19, 2020 and titled, “A Method Of and A Composition For Improving Breaking Dormancy For Perennial Fruits,” which is also hereby incorporated by reference in its entirety for all purposes.

### FIELD OF THE INVENTION

The present invention relates to plant regulator compositions. More specifically, the present invention relates to plant dormancy breaking and uniform ripening compositions.

### BACKGROUND OF THE INVENTION

Perennial fruit trees normally require enough winter chilling hours to produce regular rest breaking and crop of fruits. Problems can arise in areas with tropical and subtropical climates while there is not enough chilling accumulation, or in desert climate zones where there is insufficient or no chilling. The result of these problems can cause abnormal delayed and uneven bud breaking, flowering, poor leaf covering, and insufficient or inconsistent fruit-set and uneven ripening, which result in multiple harvest collecting.

Grapes, including fresh table grapes, wine grapes and raisin grapes are grown in such climates area, such as California USA, Mexico, China, India, Southern Europe, Turkey, Brazil, Chile, Peru, South Africa, Australia and New Zealand. In those areas, mild winters during dormancy time cause erratic budbreak and shoot emergence in spring, consequently reducing yields. The situation is worsening when global warming is accelerating today. While dormancy does not occur to an anticipate extent under unsuitable natural climates, perennial fruit trees need to artificial intervene on breaking dormancy.

Chemicals like DORMEX® (Hydrogen Cyanamide/HCN) and its generics are widely used as chemical budbreak agent to obtain uniform budbreak and even fruit set. Nonetheless, Hydrogen Cyanamide is a toxic chemical, harmful to humans, animals, bees and environments. Drifting and harmful products towards nontarget crops are serious problems as well. Hydrogen Cyanamide and similar products have been banned in EU and Turkey in the year of 2015. There is another effort, such as chemical fertilizer substance under the brand name of CAN 17® (Calcium Ammonium Nitrate) which was used as artificial intervention of rest breaking which is equally harmful to human and environments.

### SUMMARY OF THE INVENTION

Disclosed herein is a method of and composition for improving budbreak and uniformity of ripening based on Brassinolide, which is safe to all mammals, bees, crops and environment.

The present disclosure relates to methods of and compositions for, on perennial fruit crops in tropical and subtropical climates: (1) breaking dormancy improvement (also called as bud-breaking or rest breaking), such as grape including fresh table grapes, wine grapes and raisin grapes, as well as, but not limited to other perennial fruit crops such as berry fruits, pear, apple, stone fruits, kiwifruits etc.; and (2) ameliorating uniformity of ripening for manual and mechanical harvesting of such perennial fruit crops.

### BRIEF DESCRIPTION OF THE DRAWINGS

Embodiments will now be described by way of examples, with reference to the accompanying drawings which are meant to be exemplary and not limiting. For all figures mentioned herein, like numbered elements refer to like elements throughout.

FIG. 1 illustrates a plant energy absorption enhancement method by applying EBR solution in accordance with some embodiments.

FIG. 2 illustrates a bud count enhancement method in accordance with some embodiments.

FIG. 3 illustrates a ripen percentage enhancement method in accordance with some embodiments.

FIG. 4 illustrates a second bud count enhancement method in accordance with some embodiments.

FIG. 5 illustrates a second ripen percentage enhancement method in accordance with some embodiments.

FIG. 6 illustrates a dormancy breaking method in accordance with some embodiments.

### DETAILED DESCRIPTION OF THE PREFERRED EMBODIMENT

Reference is made in detail to the embodiments of the present invention, examples of which are illustrated in the accompanying drawings. While the invention is described in conjunction with the embodiments below, it is understood that they are not intended to limit the invention to these embodiments and examples. On the contrary, the invention is intended to cover alternatives, modifications and equivalents, which can be included within the spirit and scope of the invention as defined by the appended claims. Furthermore, in the following detailed description of the present invention, numerous specific details are set forth in order to more fully illustrate the present invention. However, it is apparent to one of ordinary skill in the prior art having the benefit of this disclosure that the present invention can be practiced without these specific details. In other instances, well-known methods and procedures, components and processes have not been described in detail so as not to unnecessarily obscure aspects of the present invention. It is, of course, appreciated that in the development of any such actual implementation, numerous implementation-specific decisions must be made in order to achieve the developer's specific goals, such as compliance with application and business related constraints, and that these specific goals vary from one implementation to another and from one developer to another. Moreover, it is appreciated that such a development effort can be complex and time-consuming, but is nevertheless a routine undertaking of engineering for those of ordinary skill in the art having the benefit of this disclosure.

Brassinosteroids (BRs) are naturally occurring hormone, plant growth promoting molecules, present in higher plants and lower plants. BRs are present in all plant organs such as pollen, anthers, seeds, leaves, stems, roots, flowers, grains and fruits with the highest concentrations found in pollen, seeds and fruits and considered as an obligatory plant constituent.

### Component 1

In one aspect, the compositions comprise one or more compositions from BRs family, (referred to as Component 1) which is able to be selected from one or more of the following groups Group B1 to Group B9:

Group B1: the main carbon skeleton of structures has norbrassinolide-like side chain, including:

28-Norbrassinolide, 28-Norcastasterone, 6-Deoxo-28-norcastasterone, 28-Nortyphasterol, 6-Deoxo-28-nortyphasterol, 28-Norteasterone, 6-Deoxo-28-norteasterone, 3-Dehydro-6-deoxo-28-norteasterone, and 26-Norcastasterone.

Group B2: the main carbon skeleton of structures has brassinolide-like side chain, including:

Brassinolide, Castasterone, 6-Deoxocastasterone, Typhasterol, Teasterone, 2-Epicastasterone, 3-Epicastasterone, 2,3-Diepicastasterone, 1β-Hydroxycastasterone, la-Hydroxy-3-epicastasterone, 3-Epi-6-deoxocastasterone, Teasterone-3-myristate, 3-Dehydroteasterone, Secasterone, 6-Deoxotyphasterol, 3-Dehydro-6-deoxoteasterone, 2-Deoxybrassinolide, Teasterone-3-laurate, 6-Deoxoteasterone, 6α-Hydroxycastasterone, 3-O-β-D-Glucopyranosylteasterone, 3-Epibrassinolide, 2,3-Diepisecasterone, Secasterol, Cryptolide, 23-Dehydro-2-epicastasterone, 3-Epi-2-deoxybrassinolide, and Castasterone 23-phosphate.

Group B3: the main carbon skeleton of structures has 24-epibrassinolide-like side chain, including:

24-Epicastasterone, 3,24-Diepicastasterone, 24-Epibrassinolide, 6-Deoxo-24-epicastasterone, and 24-Episecasterone.

Group B4: the main carbon skeleton of structures has dolicholide-like side chain, including:

Dolicholide, Dolichosterone, and 6-Deoxodolichosterone.

Group B5: the main carbon skeleton of structures has 28-homobrassinolide-like side chain, including:

28-Homocastasterone, 28-Homobrassinolide, 28-Homoteasterone, 28-Homotyphasterol, and 6-Deoxe-28-homotyphasterol.

Group B6: the main carbon skeleton of structure has 25-homebrassinolide-like chain, including:

25-Methylcastasterone.

Group B7: the main carbon skeleton of structure has 28-homodolicholide-like side chain, including:

28-Homodolicholide, 28-Homodolichosterone, and 6-Deoxo-28-homodolichosterone.

Group B8: the main carbon skeleton of structure has 25-homodolicholide-like side chain, including:

25-Methyldolichosterone, 2-Deoxy-25-methyldolichosterone, 3-Epi-2-deoxy-25-methyldolichosterone, 2-Epi-25-methyldolichosterone, 2,3-Diepi-25-methyldolichosterone, 6-Deoxo-25-methyldolichosterone, 23-O-β-D-Glucopyranosyl-25-methyldolichosterone, and 23-O-β-D-Glucopyranosyl-2-epi-25-methyldolichosterone.

Group B9: miscellaneous, including:

Cathasterone, 28-Epihomobrassinolide, 22,23,24-Triepibrassinolide, 14-hydroxylated brassinosteroid, 22,23-Epoxybrassinosteroid-2,3-diacetates, and Biobras-16.

In some embodiments, the Component 1 is 24-Epibrassinolide (EBR).

In some embodiments, the concentration of Component 1 in the application solution is in the range of from 0.02-50 ppm. In some embodiments, the concentration of Component 1 in the application solution is in the range of from 0.05-0.5 ppm.

In some embodiments, surfactants such as spreaders and penetration enhancers are added to the application solution to improve the efficacy. In some embodiments, surfactants used are naturally extracted chemicals, such as citrus oil and soaps or all natural extracted surfactants and penetrators. In some embodiments, surfactants used are synthesized chemicals, such as alkylphenol-alkylene oxide addition products, alcohol-alkylene oxide addition products, and organosilicone surfactants.

The application solution is able to be prepared by diluting Component 1 with water. For example, the application solution is prepared by weighing one part of 24-Epibrassinolide at 0.01% SL (Soluble Concentrate) and 750 parts of water and mixing well, which produces an application solution with a concentration of 0.133 ppm. The spreader and penetration enhancer are added according to corresponding labels.

### Component 2

In some embodiments, the application solution contains other plant regulators as component 2. Component 2 is able to be selected from one or more of the following groups including:

Group 2A: Auxins and Auxin-like compounds including Indole-3-acetic acid (IAA) and its salts, Indole-3-butyric acid (IBA) and its salts, Naphthalene-acetic acid (NAA) and its salts, 1-Naphthaleneacetamide(NDA), 4-Chlorophenoxyacetic acid (4-CPA) and its salts or esters, Ethychlozate;

Group 2B: Gibberellic acid A3 (GA3) and Gibberellins A4/A7 (GA4, GA7, GA4+7);

Group 2C: Cytokinins including 6-Benzyladenine (6-BA), Kinetin, Forchlorfenuron (CPPU), Zeatin, trans-Zeatin, Isopentenyladenine (2iP);

Group 2D: unclassified plant regulators including Triacontanol, Diethyl aminoethyl hexanoate citrate (DA6), Sodium ortho-nitrophenolate, Sodium para-nitrophenolate, Sodium 5-nitroguaiacolate, DORMEX® (Hydrogen Cyanamide), CAN 17 (Calcium Ammonium Nitrate) or a combination thereof.

In some embodiments, the Component 2 is premixed with the Component 1 and prepared with a designated/predetermined formula. In some embodiments, Component 1 is mixed with Component 2 in a tank forming the application product before use.

Crops that can use this application solution includes but not limited to pome fruits (e.g., apple and pear), stone fruits (e.g., apricot, cherry, peach, and plum), berries and small fruits (e.g., blueberry, raspberry, blackberry, grape, kiwifruit, and strawberry), tree nuts (e.g., almond, pecan, walnut, and pistachio).

The selected exemplary application method is one spraying application on the plants trunk during the dormancy period and multiple foliar applications during the fruit sizing stage and/or the early ripening stage.

### EXAMPLES

### Example 1

One greenhouse study was conducted in Sacramento, Calif. to determine the impact of dormant bud application by using 24-Epibrassinole 0.01% SL, which is compared with the application of using CAN 17 (Calcium Ammonium Nitrate 20%) @ 20 gallons/acre on table grapes.

Random Trial Design utilizes available table grapes (Thompson Seedless Variety) from Duarte Nursery in Modesto, Calif. Once placed in Greenhouse, Data Logger Heat (Delta's) wires are placed below and above one axillary buds (one per plant) of 3 plants per treatment and untreated check to determine if 24-Epibrassinolide and CAN 17 are exothermic or endothermic to the bud. Additionally, 3 more plants per treatment and untreated check are not wired. All leaves and their stems were cut ¼ of inch from adjacent axillary buds on total plant shoots. Terminal leaves were left attached. Started Data loggers.

Treatments description: misted with fine sprayer nozzle 100 gallons per acre

1.) 24-Epibrassinolide (0.01%) @ 1:750 in 100 gallons per acre spray solution (0.133 ppm)
2.) 24-Epibrassinolide (0.01%) @ 1:1000 in 100 gallons per acre spray solution (0.1 ppm)
3.) CAN 17 @20 gallons in 100 gallons per acre spray solution

### 4.) Untreated Check

TABLE 1
The results after 64 hours after applications

| Treatment | Treatment | | Absorbed energy |
|---|---|---|---|
| Number | Description | New leaves | by buds* |
| 1 | 24-Epibrassinolide | New leaves | Obvious |
| | solution (0.133 ppm) | emerged | |
| 2 | 24-Epibrassinolide | New leaves | Obvious |
| | solution (0.1 ppm) | emerged | |
| 3 | CAN 17 (Calcium | New leaves | As much as ⅓ |
| | Ammonium Nitrate | emerged | of energy |
| | 20%) @ 20 gals in | but burnt | observed from |
| | 100 gals water | | treatment 1 and 2 |
| 4 | UTC | None | None |

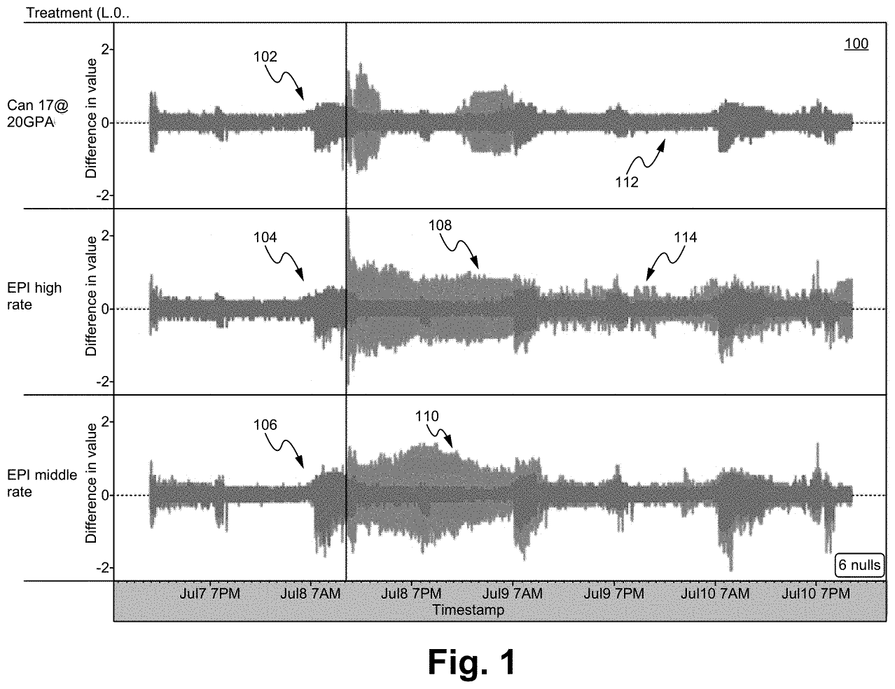

FIG. 1 illustrates a plant energy absorption enhancement method (100) by applying EBR solution in accordance with some embodiments. The results show that the applications of 0.1 or 0.133 ppm EBR solution (104), (106) lead to more energy absorbed in buds than CAN17 does (102), which is helpful for bud breaking. Referring to the FIG. 1, light gray (114) shows that energy has been absorbed by buds; and dark gray (112) shows that no energy absorption has been detected.

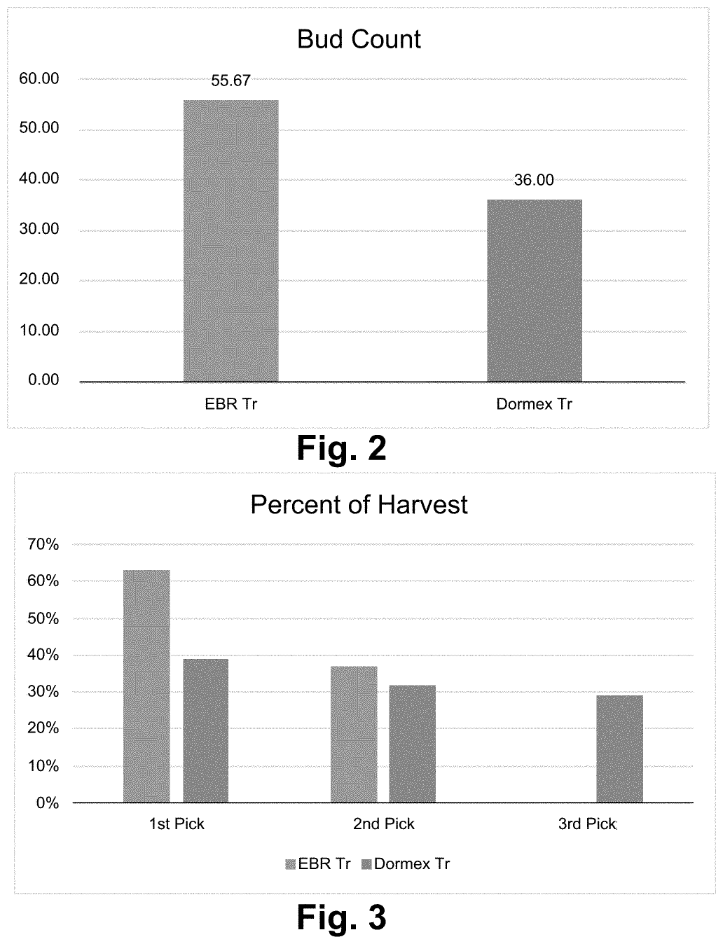

FIG. 2 illustrates a chart for bud count enhancement method in accordance with some embodiments. As shown in the FIG. 2, the bud count reaches 55.67% when the solution disclosed in the present disclosure is applied. In comparison, the bud count is only 36% when DORMEX is applied.

FIG. 3 illustrates a ripen percentage enhancement method in accordance with some embodiments. As shown in the FIG. 3, the percentage of ripening is higher by applying the solution of the present disclosure than the comparison trial using DORMEX. As a result, the plants using the solution of the present disclosure only need 2 picks.

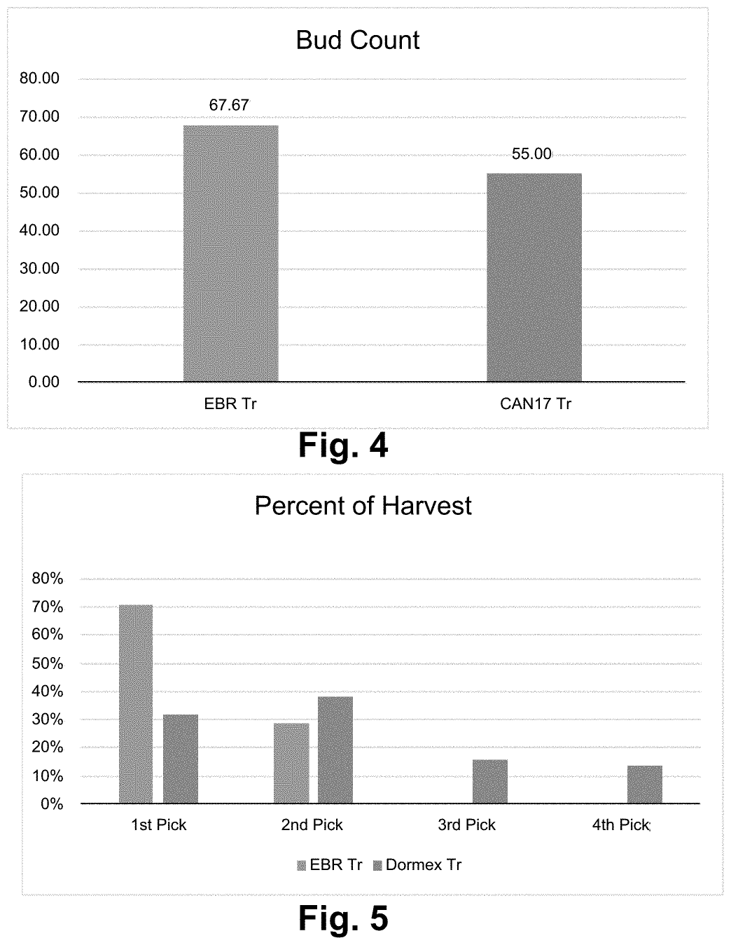

FIG. 4 illustrates a second bud count enhancement method in accordance with some embodiments. As shown in the FIG. 4, the bud count reaches 67.67% when the solution disclosed in the present disclosure is applied. In comparison, the bud count is only 55% when CAN17 is applied.

FIG. 5 illustrates a second ripen percentage enhancement method in accordance with some embodiments. As shown in the FIG. 5, the percentage of ripening is much higher at the first pick by applying the solution of the present disclosure than the comparison trial using CAN17. As a result, the plants using the solution of the present disclosure only needs 2 picks.

TABLE 2
The percentage of open buds

| Treatment | | | Buds | Open | % |
|---|---|---|---|---|---|
| No. | Treatment Description | Plot | Total | Buds | Open |
| 1 | 24-Epibrassinolide | 101 | 13 | 7 | 54 |
| | solution (0.133 ppm) | 102 | 6 | 1 | 17 |
| | | 103 | 15 | 7 | 47 |
| | | 104 | 6 | 4 | 67 |
| | | 105 | 6 | 2 | 33 |
| | Mean = | | | | 44 |
| 2 | 24-Epibrassinolide | 201 | 7 | 3 | 43 |
| | solution (0.1 ppm) | 202 | 10 | 5 | 50 |
| | | 203 | 9 | 2 | 22 |
| | | 204 | 8 | 1 | 13 |
| | | 205 | 15 | 1 | 7 |
| | Mean = | | | | 27 |
| 3 | CAN 17 (Calcium | 301 | 4 | 1 | 25 |
| | Ammonium Nitrate | 302 | 10 | 5 | 50 |
| | 20%) @ 20 gals in | 303 | 9 | 5 | 56 |
| | 100 gals | 304 | 14 | 2 | 14 |
| | water | 305 | 11 | 4 | 36 |
| | Mean = | | | | 36 |
| 4 | UTC | 401 | 11 | 2 | 18 |
| | | 402 | 13 | 2 | 15 |
| | | 403 | 8 | 2 | 25 |
| | | 404 | 15 | 5 | 33 |
| | | 405 | 11 | 5 | 45 |
| | Mean = | | | | 27 |

The treatment with 0.133 ppm 24-Epibrassinolide solution resulted in the highest percentage of open buds.

### Example 2

A table grape field trial is conducted in California to compare with the buds break effects of 24-Epibrassinolide (EBR) and Dormex® (Hydrogen Cyanamide 50%).

Random Trial Design is to utilize table grapes (scarlet royal variety) from vineyards in Coachella Valley, Mecca, Calif. There are two treatments, three replicates per treatment.

Treatments description: Foliar applied with a Sthil Air Blast Back Pack Sprayer

### Treatment 1: Sunergist EBR (24-Epibrassinode 0.01% SL)

1^{st} application: 300 mLs/100 GPA (0.079 ppm) at dormant stage;
2^{nd} application: 6.4 fl. oz/100 GPA (0.050 ppm) at small fruit (8 mm)
   Treatment 2: Dormex, the application rate was 4 gals/100 GPA

In order to improve efficacy, Vintre Adjuvant was applied at 16 fl. oz/100 GPA for all treatments.

### Evaluation Methods:

(1) Bud Break: Making bud count 3 ft each side from the center of grape vine, 5 vines/rep;
(2) Yield: Count boxes/acre for yield

TABLE 3
Bud count (EBR and DORMEX ®)

| Character Rated | | | Bud Break |
|---|---|---|---|
| Rating Date | | | 47 days after first application |
| Rating Data Type | | | Count |
| Rating Unit | | | Number |
| Tr. No | Tr. Name | Rep. | |
| 1 | EBR (0.01%) | 1 | 50 |
| | | 2 | 63 |
| | | 3 | 54 |
| | | Mean | 55.67a |
| 2 | DORMEX ® | 1 | 33 |
| | | 2 | 29 |
| | | 3 | 46 |
| | | Mean | 36.00a |

| | |
|---|---|
| LSD P = 0.05 | 32.799 |
| Standard Deviation | 11.739 |
| CV | 25.61% |
| Grand Mean | 45.833 |
| Bartlett's X2 | 0.132 |
| P (Bartlett's X2) | 0.717 |
| Friedman's X2 | 3.000 |
| P (Friedman's X2) | 0.083 |
| Skewness | −0.1704 |
| Kurtosis | −1.1557 |
| Replicate F | 0.415 |
| Replicate Prob (F) | 0.7068 |
| Treatment F | 6.656 |
| Treatment Prob (F) | 0.1231 |

TABLE 4
Harvest Data with EBR treatment

| | Boxes/45 vines/ | Boxes/ | % of |
|---|---|---|---|
| | 0.1 acre | acre | ripening |
| 1^{st} pick | 48.5 | 485 | 63% |
| 2^{nd} pick | 28.0 | 280 | 37% |
| In Total | 76.5 | 765 | 100% |

TABLE 5
Harvest Data with DORMEX treatment-
Commercial standard per acre

| | Boxes/acre | % of ripening |
|---|---|---|
| 1^{st} pick | 296 | 39% |
| 2^{nd} pick | 245 | 32% |
| 3^{rd} pick | 221 | 29% |
| In Total | 762 | 100% |

Based on the data in the tables 3-5 and FIGS. 2-3 above, it is suggested that:

(1) The application of EBR (0.01%) at the rate of 300 mL/100 GPA (0.079 ppm) resulted in 54% increase of broken bud number over DORMEX on counting date.
(2) Compared to the commercial standard treated with DORMEX, the treatment with EBR (0.079 ppm and 0.05 ppm) can reduce the table grape picking times from 3 picks to 2 picks. Also, at the 1st pick, 63% of table grapes treated with EBR were ready to pick, and it is much higher than the DORMEX treatment, which is 39%.

### Example 3

A table grape field trial is conducted in California to compare with the buds break effects of 24-Epibrassinolide (EBR) and CAN 17® (Calcium Ammonium Nitrate).

Random Trial Design is to utilize table grapes (Early Sweet Seedless variety) from vineyards in Coachella Valley, Mecca, Calif. There are two treatments, three replicates per treatment.

Treatments description: Foliar applied with a Sthil Air Blast Back Pack Sprayer

### Treatment 1: Sunergist EBR (24-Epibrassinode 0.01% SL)

1^{st} application: 300 mLs/100 GPA (0.079 ppm) at dormant stage;
2^{nd} application: 6.4 fl. oz/100 GPA (0.050 ppm) at small fruit (8 mm)
   Treatment 2: CAN 17, the application rate was 20 gals/100 GPA In order to improve efficacy, Vintre Adjuvant was applied at 16 fl. oz/100 GPA for the treatment 1

### Evaluation Methods:

(1) Bud-breaking: Making bud count 3 ft each side from the center of grape vine, 5 vines/rep;
(2) Yields: Count boxes/acre for yield

TABLE 6
Bud count (EBR and CAN 17 ®)

| Character Rated | | | Bud Break |
|---|---|---|---|
| Rating Date | | | 43 days after first application |
| Rating Data Type | | | Count |
| Rating Unit | | | Number |
| Tr. No | Tr. Name | Rep. | |
| 1 | EBR (0.01) @ | 1 | 47 |
| | 300 mL/100 | 2 | 89 |
| | GPA (1:1237 | 3 | 67 |
| | dilution rate) | Mean | 67.67a |
| 2 | CAN 17 ® @ | 1 | 49 |
| | 20 gal/100 GPA | 2 | 57 |
| | | 3 | 59 |
| | | Mean | 55.00a |

| | |
|---|---|
| LSD P = 0.05 | 43.407 |
| Standard Deviation | 14.020 |
| CV | 22.86% |
| Grand Mean | 61.333 |
| Bartlett's X2 | 2.391 |
| P (Bartlett's X2) | 0.122 |
| Friedman's X2 | 0.333 |
| P (Friedman's X2) | 0.564 |
| Skewness | 1.3619 |
| Kurtosis | 1.9621 |
| Replicate F | 2.074 |
| Replicate Prob (F) | 0.3253 |
| Treatment F | 1.576 |
| Treatment Prob (F) | 0.3361 |

TABLE 7
Harvest Data with EBR treatment

| | Boxes/45 vines/ | Boxes/ | % of |
|---|---|---|---|
| | 0.1 acre | acre | ripening |
| 1^{st} pick | 85.5 | 855 | 71% |
| 2^{nd} pick | 35.5 | 355 | 29% |
| In Total | 121.0 | 1210 | 100% |

TABLE 8
Harvest Data with CAN 17 treatment-
Commercial standard per acre

| | Boxes/acre | % of ripening |
|---|---|---|
| 1^{st} pick | 390 | 32% |
| 2^{nd} pick | 451 | 38% |
| 3^{rd} pick | 190 | 16% |
| 4^{th} pick | 167 | 14% |
| In Total | 1198 | 100% |

Based on the data in the tables 6-8 and FIGS. 4-5 above, it suggested that:

(1) The application of EBR (0.01%) at the rate of 300 mL/100 GPA (0.079 ppm) resulted in 23% increase of broken bud number over CAN 17 on counting date.
(2) Compared to the commercial standard treated with CAN17, the treatment with EBR (0.079 ppm and 0.05 ppm) can reduce the table grape picking times from 4 picks to 2 picks. Also, at the 1st pick, 71% of table grapes treated with EBR was ready to pick, and it is much higher than the CAN17 treatment, which is 32%.

### Example 4

A table grape field trial is conducted in table grapes (Autumn King variety) from vineyards in Kern county, California to compare with the buds break effects of 24-Epibrassinolide (EBR) and Kropmax (Hydrogen Cyanamide 50%).

TABLE 9
Treatments description

| | Application | Application | Application |
|---|---|---|---|
| Treatment | rate | timing | method |
| 1. Sunergist | 10 fl. Oz/100 | at dormant | Spraying on |
| EBR | gals/Acre | stage | the trunk |
| 0.01% SL | (0.079 ppm) | | |
| 2. Kropmax | 3.0 gal | at dormant | Spraying on |
| (HCN | product/100 | stage | the trunk |
| 50% L) | gals/Acre | | |

Surf-90 at 1.75 per ac was added to each treatment

### Evaluation Methods:

(1) Randomized select 6 vines per replicates, 4 replicates per treated block;
(2) 2. Making bud count 3 ft each side from the center of each grape vine

TABLE 10
Bud count (EBR and DORMEX ®)

| Character Rated | | | Bud Break |
|---|---|---|---|
| Rating Date | | | 41 days after first application |
| Rating Data Type | | | Count |
| Rating Unit | | | Number |
| Tr. No | Tr. Name | Rep. | |
| 1 | Sunergist EBR | 1 | 102 |
| | | 2 | 93 |
| | | 3 | 90 |
| | | 4 | 112 |
| | | Mean | 99.25 |
| 2 | Kropmax | 1 | 87 |
| | (HCN 50% L) | 2 | 89 |
| | | 3 | 95 |
| | | 4 | 78 |
| | | Mean | 87.25 |

| | |
|---|---|
| LSD P = 0.05 | 26.721 |
| Standard Deviation | 9.562 |
| CV | 10.25% |
| Grand Mean | 93.250 |
| Bartlett's X2 | 0.295 |
| P (Bartlett's X2) | 0.587 |
| Friedman's X2 | 1.000 |
| P (Friedman's X2) | 0.317 |
| Skewness | 0.6000 |
| Kurtosis | 0.9246 |
| Replicate F | 0.048 |
| Replicate Prob (F) | 0.9834 |
| Treatment F | 2.043 |
| Treatment Prob (F) | 0.2483 |

This field test illustrated that the EBR application at 0.079 ppm showed excellent rest breaking of dormant buds of table grape that is equal or better than HCN 50% L in this test.

### Example 5

Near Mount Compass, South Australia, Sunergist was applied at four rates (250, 500, 1000 and 1500 mL/100 L, equivalent to 0.25, 0.50, 1.00, 1.50 ppm) with Pomade (0.1% v/v) and compared to DORMEX® (4000 mL/100 L) with Pomade (0.1% v/v) and an untreated control to evaluate the efficacy and crop safety of the present disclosure for early and even bud-break, fruit set and ripening of blueberries (Vaccinium (sec. Cyanococcus) corymbosum) c.v. Reka.

Treatments were applied using a hand-pump spray unit with one hollow cone nozzle. One application, 35-40 days prior to anticipated bud-break was made. Treatments were applied at a volume of 600 L/ha, which achieved point of run-off.

The trial design adopted was a randomised complete block design with five replicates of six treatments. Total trial dimensions were 3 m×32 m, inclusive of all buffer zones.

TABLE 11
Mean percentage of buds that had broken
at bud break on n = 4 branches per bush.

| Trt | Treatment | | | Bud break | |
|---|---|---|---|---|---|
| No. | Name | Rate | Unit | (%) | |
| 1 | Untreated control | | | 52.0 | c |
| 2 | Dormex | 4000 | mL/100 L | 74.5 | ab |
| 3 | Sunergist SL | 250 | mL/100 L | 72.9 | ab |
| 4 | Sunergist SL | 500 | mL/100 L | 79.7 | a |
| 5 | Sunergist SL | 1000 | mL/100 L | 73.1 | ab |
| 6 | Sunergist SL | 1500 | mL/100 L | 59.8 | bc |

| | |
|---|---|
| LSD P = .05 | 15.348 |
| Standard Deviation | 11.502 |
| CV | 16.67 |
| Bartlett's X2 | 8.128 |
| P (Bartlett's X2) | 0.149 |
| Replicate F | 0.714 |
| Replicate Prob (F) | 0.5938 |
| Treatment F | 3.926 |
| Treatment Prob (F) | 0.0150 |

TABLE 12
Mean percentage of buds that were floral at early bloom, the cumulative
percentage of floral buds that were early development (tight or pink) versus later stages of
blooming (bloom, full bloom or petal fall) and the distribution variance for floral buds in
each category on n = 4 branches per bush.

| Trt | Treatment | | | Floral | | Tight/Pink | | Bloom − Petal fall | | | |
|---|---|---|---|---|---|---|---|---|---|---|---|
| No. | Name | Rate | Unit | (%) | | (%) | | (%) | | Variance | |
| 1 | Untreated control | | | 17.56 | — | 88.3 | a | 11.7 | b | 0.402 | — |
| 2 | Dormex | 4000 | mL/100 L | 18.00 | — | 84.5 | a | 15.5 | b | 0.288 | — |
| 3 | Sunergist SL | 250 | mL/100 L | 14.74 | — | 72.7 | ab | 27.3 | ab | 0.685 | — |
| 4 | Sunergist SL | 500 | mL/100 L | 19.34 | — | 60.3 | b | 39.7 | a | 0.862 | — |
| 5 | Sunergist SL | 1000 | mL/100 L | 15.02 | — | 83.2 | a | 16.8 | b | 0.304 | — |
| 6 | Sunergist SL | 1500 | mL/100 L | 23.39 | — | 81.4 | a | 18.6 | b | 0.722 | — |

| | | | | |
|---|---|---|---|---|
| LSD P = .10 | 7.7601 | 15.6882 | 15.6882 | 0.6189 |
| Standard Deviation | 7.0532 | 14.2591 | 14.2591 | 0.5625 |
| CV | 39.17 | 18.19 | 66.03 | 103.43 |
| Bartlett's X2 | 2.526 | 2.885 | 2.885 | 13.902 |
| P(Bartlett's X2) | 0.773 | 0.718 | 0.718 | 0.016* |
| Replicate F | 2.24 | 4.728 | 4.728 | 1.091 |
| Replicate Prob(F) | 0.1077 | 0.0095 | 0.0095 | 0.3922 |
| Treatment F | 1.015 | 2.599 | 2.598 | 0.936 |
| Treatment Prob(F) | 0.4392 | 0.0638 | 0.0638 | 0.4826 |

TABLE 13
Mean estimated number of picks required to
harvest all fruit from bushes at optimum ripeness

| Trt | Treatment | | | Estimated Picks | |
|---|---|---|---|---|---|
| No. | Name | Rate | Unit | (number) | |
| 1 | Untreated control | | | 3.2 | — |
| 2 | Dormex | 4000 | mL/100 L | 2.4 | — |
| 3 | Sunergist SL | 250 | mL/100 L | 2.2 | — |
| 4 | Sunergist SL | 500 | mL/100 L | 2.5 | — |
| 5 | Sunergist SL | 1000 | mL/100 L | 2.4 | — |
| 6 | Sunergist SL | 1500 | mL/100 L | 2.7 | — |

| | |
|---|---|
| LSD P = .10 | 0.8536 |
| Standard Deviation | 0.7783 |
| CV | 30.28 |
| Bartlett's X2 | 2.058 |
| P (Bartlett's X2) | 0.841 |
| Replicate F | 0.352 |
| Replicate Prob (F) | 0.8395 |
| Treatment F | 1.034 |
| Treatment Prob (F) | 0.4276 |

Sunergist (e.g., embodiment of the present disclosure) applied at 500 mL/100 L (0.5 ppm) generally performed as well as, or better than, DORMEX (4000 mL/100 L) across all assessments. Sunergist at 500 mL/100 L (0.5 ppm) matched the performance of DORMEX® (4000 mL/100 L) for the percentage buds open at early bud break (Table 11), and out-performed DORMEX® (4000 mL/100 L) for the developmental stage of flower buds at early flower, with Sunergist (500 mL/100 L, 0.5 ppm) having 24.2% more flower buds at bloom to petal fall relative to DORMEX® (4000 mL/100 L) (Table 12). Sunergist (500 mL/100 L, 0.5 ppm) performed as well as DORMEX® (4000 mL/100 L) for the estimated number of picks required to harvest all fruit from bushes at optimum ripeness (Table 13).

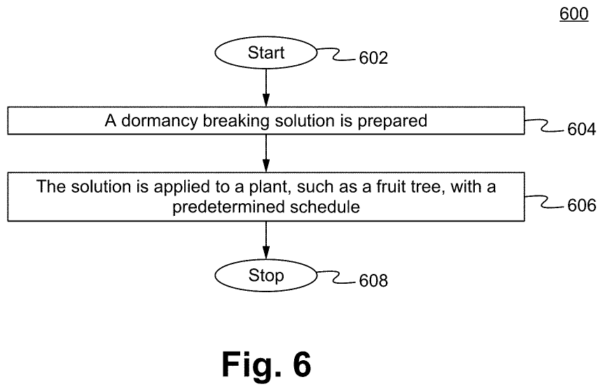

FIG. 6 illustrates a dormancy breaking and uniform ripening method 600 in accordance with some embodiments. The method 600 starts at Step 602.

At Step 604, a dormancy breaking and uniform ripening solution is prepared. In some embodiments, the solution contains a first compound, a second compound, or both. The first compound is able to be the Component 1 mentioned above. In some embodiments, the second compound is able to be the Component 2 mentioned above. In some embodiments, the first compound and/or the second compound is prepared having a predetermined concentration.

At Step 606, the solution is applied to a plant, such as a fruit tree/vines, with a predetermined schedule. The application includes applying the solution to the trunk and foliar of the plant.

The method 600 stops at a Step 608.

In utilization, the application solution disclosed herein is applied to facilitate bud-breaking and uniform ripening of the fruits including perennial fruits.

In operation, an application solution having a compound from the BRs family with a predetermined concentration (e.g., 24-Epibrassinode 0.01% SL) is prepared and used to be applied on the subject plants.

We claim:

1. A method of improving bud-breaking and uniformity of ripening in fruit crops comprising:
a) preparing an application solution containing a first compound from a Brassinosteroids (BRs) family; and
b) applying the solution on a plant at a concentration equal or higher than 0.05 ppm.

2. The method of claim 1, wherein the first compound comprises 24-Epibrassinolide.

3. The method of claim 1, wherein a concentration of the first compound in the application solution is 0.05-50 ppm.

4. The method of claim 1, wherein a concentration of the first compound in the application solution is 0.05-0.5 ppm.

5. The method of claim 1, wherein the application solution comprises a second compound of a plant regulator, which is not a member of the Brassinosteroids (BRs) family.

6. The method of claim 5, wherein the application solution is in a form of a premixed solution having the first compound and the second compound.

7. The method of claim 5, further comprising mixing first compound and the second compound in a tank before an application of the application solution.

8. The method of claim 1, wherein the fruit crops comprise pome fruits.

9. The method of claim 8, wherein the pome fruits comprise apples and pears.

10. The method of claim 1, wherein the fruit crops comprise stone fruits.

11. The method of claim 10, wherein the stone fruits comprise apricot, cherry, peach, and plum.

12. The method of claim 1, wherein the fruit crops comprise berries and small fruits.

13. The method of claim 12, wherein the berries and small fruits comprise blueberry, raspberry, blackberry, grape, kiwifruit, and strawberry.

14. The method of claim 1, wherein the fruit crops comprise tree nuts.

15. The method of claim 14, wherein the tree nuts comprise almond, pecan, walnut, and pistachio.

16. The method of claim 1, wherein the applying the solution on a plant comprises one spraying application on a plant's trunk during the dormancy period and one or more foliar applications during a fruit sizing stage or an early ripening stage.

17. A method of plant treating comprising:
a) preparing a plant treating solution, wherein the plant treating solution comprises a first compound from a Brassinosteroids (BRs) family; and
b) facilitating a bud-breaking of a plant by applying the plant treating solution to the plant at the plant's a dormant stage.

18. The method of claim 17, wherein the first compound comprises 24-Epibrassinolide.

19. The method of claim 17, wherein the first compound comprises a structure having a main carbon skeleton with a norbrassinolide-like side chain.

20. The method of claim 19, wherein the first compound comprises 28-Norbrassinolide, 28-Norcastasterone, 6-Deoxo-28-norcastasterone, 28-Nortyphasterol, 6-Deoxo-28-nortyphasterol, 28-Norteasterone, 6-Deoxo-28-norteasterone, 3-Dehydro-6-deoxo-28-norteasterone, or 26-Norcastasterone.

21. The method of claim 17, wherein the first compound comprises a structure having a main carbon skeleton with a brassinolide-like side chain.

22. The method of claim 21, wherein the first compound comprises Brassinolide, Castasterone, 6-Deoxocastasterone, Typhasterol, Teasterone, 2-Epicastasterone, 3-Epicastasterone, 2,3-Diepicastasterone, 1β-Hydroxycastasterone, 1α-Hydroxy-3-epicastasterone, 3-Epi-6-deoxocastasterone, Teasterone-3-myristate, 3-Dehydroteasterone, Secasterone, 6-Deoxotyphasterol, 3-Dehydro-6-deoxoteasterone, 2-Deoxybrassinolide, Teasterone-3-laurate, 6-Deoxoteasterone, 6α-Hydroxycastasterone, 3-O-β-D-Glucopyranosylteasterone, 3-Epibrassinolide, 2,3-Diepisecasterone, Secasterol, Cryptolide, 23-Dehydro-2-epicastasterone, 3-Epi-2-deoxybrassinolide, or Castasterone 23-phosphate.

23. The method of claim 17, wherein the first compound comprises a structure having a main carbon skeleton with a 24-epibrassinolide-like side chain.

24. The method of claim 23, wherein the first compound comprises 24-Epicastasterone, 3,24-Diepicastasterone, 24-Epibrassinolide, 6-Deoxo-24-epicastasterone, or 24-Episecasterone.

25. The method of claim 17, wherein the first compound comprises a structure having a main carbon skeleton with a dolicholide-like side chain.

26. The method of claim 25, wherein the first compound comprises Dolicholide, Dolichosterone, or 6-Deoxodolichosterone.

27. The method of claim 17, wherein the first compound comprises a structure having a main carbon skeleton with a 28-homobrassinolide-like side chain.

28. The method of claim 27, wherein the first compound comprises 28-Homocastasterone, 28-Homobrassinolide, 28-Homoteasterone, 28-Homotyphasterol, or 6-Deoxe-28-homotyphasterol.

29. The method of claim 17, wherein the first compound comprises a structure having a main carbon skeleton with a 25-homebrassinolide-like chain.

30. The method of claim 29, wherein the first compound comprises 25-Methylcastasterone.

31. The method of claim 17, wherein the first compound comprises a structure having a main carbon skeleton with a 28-homodolicholide-like side chain.

32. The method of claim 31, wherein the first compound comprises 28-Homodolicholide, 28-Homodolichosterone, or 6-Deoxo-28-homodolichosterone.

33. The method of claim 17, wherein the first compound comprises a structure having a main carbon skeleton with a 25-homodolicholide-like side chain.

34. The method of claim 33, wherein the first compound comprises 25-Methyldolichosterone, 2-Deoxy-25-methyldolichosterone, 3-Epi-2-deoxy-25-methyldolichosterone, 2-Epi-25-methyldolichosterone, 2,3-Diepi-25-methyldolichosterone, 6-Deoxo-25-methyldolichosterone, 23-O-β-D-Glucopyranosyl-25-methyldolichosterone, and 23-O-β-D-Glucopyranosyl-2-epi-25-methyldolichosterone.

35. The method of claim 17, wherein the first compound comprises Cathasterone, 28-Epihomobrassinolide, 22,23,24-Triepibrassinolide, 14-hydroxylated brassinosteroid, 22,23-Epoxybrassinosteroid-2,3-diacetates, or Biobras-16.

36. The method of claim 17, wherein the plant treating solution further comprises a second compound that is a non-Brassinosteroids (BRs) family plant regulator.

37. The method of claim 36, wherein the second compound comprises Auxins and Auxin-like compounds, Indole-3-butyric acid (IBA) and its salts, Naphthalene-acetic acid (NAA) and its salts, 1-Naphthaleneacetamide(NDA), 4-Chlorophenoxyacetic acid (4-CPA) and its salts or esters, or Ethychlozate.

38. The method of claim 36, wherein the second compound comprises Gibberellic acid A3 (GA3) or Gibberellins A4/A7 (GA4, GA7, GA4+7).

39. The method of claim 36, wherein the second compound comprises Cytokinins including 6-Benzyladenine (6-BA), Kinetin, Forchlorfenuron (CPPU), Zeatin, trans-Zeatin, or Isopentenyladenine (2iP).

40. The method of claim 36, wherein the second compound comprises Triacontanol, Diethyl aminoethyl hexanoate citrate (DA6), Sodium ortho-nitrophenolate, Sodium para-nitrophenolate, Sodium 5-nitroguaiacolate, DORMEX® (Hydrogen Cyanamide), CAN 17 (Calcium Ammonium Nitrate) or a combination thereof.

41. A fruit uniform ripening enhancing solution comprises:
a) a first compound from a brassinosteroids (BRs) family; and
b) a water solution containing the first compound having a concentration no less than 0.05 ppm.

42. The solution of claim 41, wherein the brassinosteroids (BRs) family comprises 24-Epibrassinolide.

43. The solution of claim 41, wherein the water solution is a foliar spray.

44. The solution of claim 41, wherein the first compound comprises a structure having a main carbon skeleton with a norbrassinolide-like side chain.

45. The solution of claim 44, wherein the first compound comprises 28-Norbrassinolide, 28-Norcastasterone, 6-Deoxo-28-norcastasterone, 28-Nortyphasterol, 6-Deoxo-28-nortyphasterol, 28-Norteasterone, 6-Deoxo-28-norteasterone, 3-Dehydro-6-deoxo-28-norteasterone, or 26-Norcastasterone.

46. The solution of claim 41, wherein the first compound comprises a structure having a main carbon skeleton with a brassinolide-like side chain.

47. The solution of claim 46, wherein the first compound comprises Brassinolide, Castasterone, 6-Deoxocastasterone, Typhasterol, Teasterone, 2-Epicastasterone, 3-Epicastasterone, 2,3-Diepicastasterone, 1β-Hydroxycastasterone, 1α-Hydroxy-3-epicastasterone, 3-Epi-6-deoxocastasterone, Teasterone-3-myristate, 3-Dehydroteasterone, Secasterone, 6-Deoxotyphasterol, 3-Dehydro-6-deoxoteasterone, 2-Deoxybrassinolide, Teasterone-3-laurate, 6-Deoxoteasterone, 6α-Hydroxycastasterone, 3-O-β-D-Glucopyranosylteasterone, 3-Epibrassinolide, 2,3-Diepisecasterone, Secasterol, Cryptolide, 23-Dehydro-2-epicastasterone, 3-Epi-2-deoxybrassinolide, or Castasterone 23-phosphate.

48. The solution of claim 41, wherein the first compound comprises a structure having a main carbon skeleton with a 24-epibrassinolide-like side chain.

49. The solution of claim 48, wherein the first compound comprises 24-Epicastasterone, 3,24-Diepicastasterone, 24-Epibrassinolide, 6-Deoxo-24-epicastasterone, or 24-Episecasterone.

50. The solution of claim 41, wherein the first compound comprises a structure having a main carbon skeleton with a dolicholide-like side chain.

51. The solution of claim 50, wherein the first compound comprises Dolicholide, Dolichosterone, or 6-Deoxodolichosterone.

52. The solution of claim 41, wherein the first compound comprises a structure having a main carbon skeleton with a 28-homobrassinolide-like side chain.

53. The solution of claim 52, wherein the first compound comprises 28-Homocastasterone, 28-Homobrassinolide, 28-Homoteasterone, 28-Homotyphasterol, or 6-Deoxe-28-homotyphasterol.

54. The solution of claim 41, wherein the first compound comprises a structure having a main carbon skeleton with a 25-homebrassinolide-like chain.

55. The solution of claim 54, wherein the first compound comprises 25-Methylcastasterone.

56. The solution of claim 41, wherein the first compound comprises a structure having a main carbon skeleton with a 28-homodolicholide-like side chain.

57. The solution of claim 56, wherein the first compound comprises 28-Homodolicholide, 28-Homodolichosterone, or 6-Deoxo-28-homodolichosterone.

58. The solution of claim 41, wherein the first compound comprises a structure having a main carbon skeleton with a 25-homodolicholide-like side chain.

59. The solution of claim 58, wherein the first compound comprises 25-Methyldolichosterone, 2-Deoxy-25-methyldolichosterone, 3-Epi-2-deoxy-25-methyldolichosterone, 2-Epi-25-methyldolichosterone, 2,3-Diepi-25-methyldolichosterone, 6-Deoxo-25-methyldolichosterone, 23-O-β-D-Glucopyranosyl-25-methyldolichosterone, and 23-O-β-D-Glucopyranosyl-2-epi-25-methyldolichosterone.

60. The solution of claim 41, wherein the first compound comprises Cathasterone, 28-Epihomobrassinolide, 22,23,24-Triepibrassinolide, 14-hydroxylated brassinosteroid, 22,23-Epoxybrassinosteroid-2,3-diacetates, or Biobras-16.

61. The solution of claim 41, wherein the water solution further comprises a second compound that is a non-Brassinosteroids (BRs) family plant regulator.

62. The solution of claim 61, wherein the second compound comprises Auxins and Auxin-like compounds, Indole-3-butyric acid (IBA) and its salts, Naphthalene-acetic acid (NAA) and its salts, 1-Naphthaleneacetamide(NDA), 4-Chlorophenoxyacetic acid (4-CPA) and its salts or esters, or Ethychlozate.

63. The solution of claim 61, wherein the second compound comprises Gibberellic acid A3 (GA3) or Gibberellins A4/A7 (GA4, GA7, GA4+7).

64. The solution of claim 61, wherein the second compound comprises Cytokinins including 6-Benzyladenine (6-BA), Kinetin, Forchlorfenuron (CPPU), Zeatin, trans-Zeatin, or Isopentenyladenine (2iP).

65. The solution of claim 61, wherein the second compound comprises Triacontanol, Diethyl aminoethyl hexanoate citrate (DA6), Sodium ortho-nitrophenolate, Sodium para-nitrophenolate, Sodium 5-nitroguaiacolate, DORMEX® (Hydrogen Cyanamide), CAN 17 (Calcium Ammonium Nitrate) or a combination thereof.
